(19) United States
(12) Patent Application Publication
(10) Pub. No.: US 2012/0059850 A1
(43) Pub. Date: Mar. 8, 2012

(54) COMPUTERIZED FACE PHOTOGRAPH-BASED DATING RECOMMENDATION SYSTEM

(76) Inventors: Jonathan Binnings Bent, Los Angeles, CA (US); Aaron Liu, Shanghai (CN); Kenneth Zhou, Shanghai (CN)

(21) Appl. No.: 12/876,197

(22) Filed: Sep. 6, 2010

(51) Int. Cl. G06F 17/30

(52) U.S. Cl. 707/776; 707/E17.014

(57) ABSTRACT

A computer vision dating system analyzes combinations of face features of the system's user's photographs and recommends potential dating partners. A user selects preferred and not-preferred faces from a sample of other user's pictures. The system analyzes the features of the preferred and not-preferred faces comparing the combinations of features in both categories with the features of other users in the database to find the users that most match the collective features preferred by the user. These pictures are presented to the user. Data from the user's profile input are analyzed to automatically generate the sample pictures from which the user selects his/her preferences. As the users are presented pictures after their sample selection, they can continue to select and reject pictures allowing the system to learn and refine the combinations of features and better locate those that most conform to a user's most preferred photo images.

### FIELD OF THE INVENTION

The present patent relates to a computer vision based dating recommendation system

### BACKGROUND OF THE INVENTION

The Internet has evolved significantly over past decades. With the speedy development of the internet, applications have grown rapidly such as Search Engines, Blogs, Social networking websites, E-commerce websites etc.

In these applications, social networking websites have become more and more popular. These websites enable users to create a profile of their personal information, keep in touch with their friends and even meet new people with similar interests. Some of the social websites are dating websites which members join in order to find suitable persons to date.

However, it is very difficult to find people to whom the user is attracted by their appearance and who may be attracted to the user especially in the large mass of people on dating websites. The search effort done manually can be time consuming and impractical. In attempts to solve the problem, search methods have been created, one of which is disclosed in U.S. Pat. No. 7,657,493 [B2]. However, these search methods are primarily based on preset search conditions like age, interests, location, salary etc. While sorting for common interests, educational background, age and other such criteria is a simple database storage and search function there is currently no satisfactory similar search option regarding physical attractiveness. In dating sites, information like facial structure and features to which a user is attracted and which cannot be listed as words in a profile are often more important to guide users in finding their potential match among members.

In other words, much useful information hidden in people's perception of another's photograph is not applied and therefore lost in a conventional system.

In the area of E-commerce, the structure of E-Commerce websites became more and more complex and hard for consumers to find the products and service they wanted. To avoid this problem, a recommendation system is proposed to suggest products and to provide consumers with information to help them decide which products to purchase, one of which is disclosed in U.S. Pat. No. 6,370,513.

However, recommendation systems in E-commerce can only find the relationship between different products by customer purchase history. In dating sites, the subjects of the selection process are human beings instead of products.

In other words, the difficulty in finding another person who is attractive to a user is a problem that conventional E-commerce recommendation methods are unable to solve.

The face is one of the most important and distinctive features of a human being. To find the similar faces between an input image and each registered image, some general face recognition methods are used, one of which is disclosed in U.S. Pat. No. 7,430,315.

A face recognition method can only recognize faces and find the relationship between different face images. However, it cannot determine the real behavioral and emotional intention of a user nor recommend attractive faces and filter out non-attractive faces to a user for the purposes of an E-commerce dating website.

In conventional recommendation systems, enjoyable and appealing products are recommended by the system. Filter functions are nonexistent in those systems except for some preset conditions. However, in dating sites, a system filter which can largely reduce search scopes for users is important. For example, besides members to which a user is attracted, members to which a user is not attracted are also needed to be found.

### SUMMARY OF THE INVENTION

In consideration of the above-mentioned problems in conventional systems and in order to accomplish a recommendation service using image information, the present invention is intended to provide a computer vision based dating recommendation system which can realize attracted members match functions and non-attracted members filter functions.

According to the first aspect of the present invention, there is provided a computer vision based dating recommendation system comprising:

Attracted members seed samples generation means when building a user's profile.

Potential attracted member classes mining means for extending attracted members seed samples generation means.

Attracted members match means concerning matching the most suitable members for users based on selected samples

According to the second aspect of the present invention, there is provided a computer vision based dating recommendation system comprising:

Non-attracted members seed samples generation means when building user's profile.

Potential non-attracted member classes mining means for extending non-attracted members seed samples generation means.

Non-attracted members match means concerning matching the most unsuitable members for users based on selected samples.

According to the third aspect of the present invention, there is provided a computer vision based dating recommendation system comprising:

Said attracted members seed samples generation means in the first aspect of the present invention comprising recommendation means for pre-generation of attracted member samples automatically means and manual selection and modification means based on said pre-generation of attracted member samples.

Said pre-generation of attracted member samples automatically means mine the relationship between attracted members and user's profile automatically when new users register into the system.

Said manual selection and modification means further set the seed samples based on said pre-generation of attracted member samples.

According to the fourth aspect of the present invention, there is provided a computer vision based dating recommendation system comprising:

Said non-attracted members seed samples generation means in the first aspect of the present invention comprises recommendation means for pre-generation of non-attracted member samples automatically means and manual selection and modification means based on said pre-generation of non-attracted member samples.

Said pre-generation of non-attracted member samples automatically means mine the relationship between non-attracted members and user's profile automatically when new users register into the system.

Said manual selection and modification means further set the seed samples based on said pre-generation of non-attracted member samples.

According to the fifth aspect of the present invention, there is provided a computer vision based dating recommendation system comprising:

Said potential attracted member classes mining means in the first aspect of the present invention comprise means of mining the relationship between user profiles and attracted member classes.

According to the sixth aspect of the present invention, there is provided a computer vision based dating recommendation system comprising:

Said potential non-attracted member classes mining means in the first aspect of the present invention comprise means of mining the relationship between user profiles and non-attracted member classes.

According to the seventh aspect of the present invention, there is provided a computer vision based dating recommendation system comprising:

Said attracted members match means in the first aspect of the present invention comprise means of attracted facial features extractions and means of attracted facial class matching and means of attracted facial matching.

Said means of attracted facial features extractions is generated from original member faces.

Said means of attracted facial class matching finds the relationship between attracted seed samples and attracted classes of member faces in the database.

Said means of attracted facial matching finds the relationship between attracted seed samples and attracted member faces in said attracted facial classes.

According to the eighth aspect of the present invention, there is provided a computer vision based dating recommendation system comprising:

Said non-attracted members match means in the first aspect of the present invention comprise means of non-attracted facial features extractions and means of non-attracted facial class matching and means of non-attracted facial matching.

Said means of non-attracted facial features extractions is generated from original member faces.

Said means of non-attracted facial class matching finds the relationship between non-attracted seed samples and non-attracted classes of member faces in the database.

Said means of non-attracted facial matching finds the relationship between non-attracted seed samples and non-attracted member faces in said non-attracted facial classes.

The present invention provides advantages in the areas of finding attracted members or avoiding non-attracted members. Once face images are stored in the database, the internal relationships between members are mined and matching or filtering results are generated according to the certain requirement. Since richer information existing in faces is taken advantage of and mined, a more reasonable recommendation performance can be achieved using the present system.

### BRIEF DESCRIPTION OF THE DRAWINGS

FIG. 1 is a flow diagram of computer vision based dating recommendation system.

FIG. 2 is a block diagram of system framework and structure.

FIG. 3 is a flow chart diagram of finding attracted and non-attracted members.

FIG. 4 is a block diagram of auto initialized attracted member seed samples.

FIG. 5 is a table recording the history of users' behavior for generating seed samples.

FIG. 6 is a figure of part of the questionnaire of users' profile.

FIG. 7 is a diagram of rules tree for generating seed samples.

FIG. 8 is a block diagram of auto initialized non-attracted member seed samples.

FIG. 9 is a block diagram of generation of potential attracted member module

FIG. 10 is a table recording the history of users' behavior for generating potential class.

FIG. 11 is a diagram of rules tree for generating potential class.

FIG. 12 is a block diagram of generation of potential non-attracted member module

FIG. 13 is a block diagram of attracted members match module.

FIG. 14 is a diagram of finding matched attracted members according to their priorities.

FIG. 15 is a block diagram of non-attracted members match module.

FIG. 16 is a block diagram of pre-generation attracted members mining.

FIG. 17 is a block diagram of pre-generation non-attracted members mining.

FIG. 18 is a block diagram of potential attracted member mining module.

FIG. 19 is a block diagram of potential non-attracted member mining module.

### DESCRIPTION OF THE PREFERRED EMBODIMENTS

Embodiments in accordance with the present invention will be described below referring to the accompanying drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of them claimed subject matter.

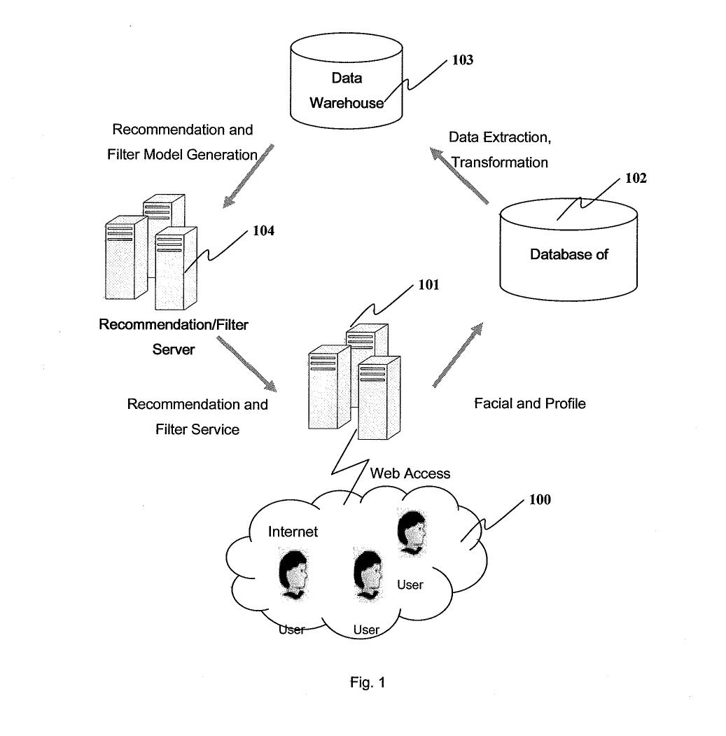

Referring initially to FIG. 1, the flow of dating recommendation system is depicted. The system server 101 can be accessible to users 100 over an internet. Profiles, personal face image, candidate attracted or non-attracted selection history and or other register information will be saved or updated in the database of dating website 102. Based on original data in 102, data in 102 are processed like data extraction, data transformation, facial features, facial classes etc and saved in data warehouse 103. Based on the data saved in 103, facial match model, recommendation model or filter model are generated and saved in server 104. According to the number of samples input by users or other input information, server 104 provides recommendation or filter service at real time. These output results are provided to user through 101.

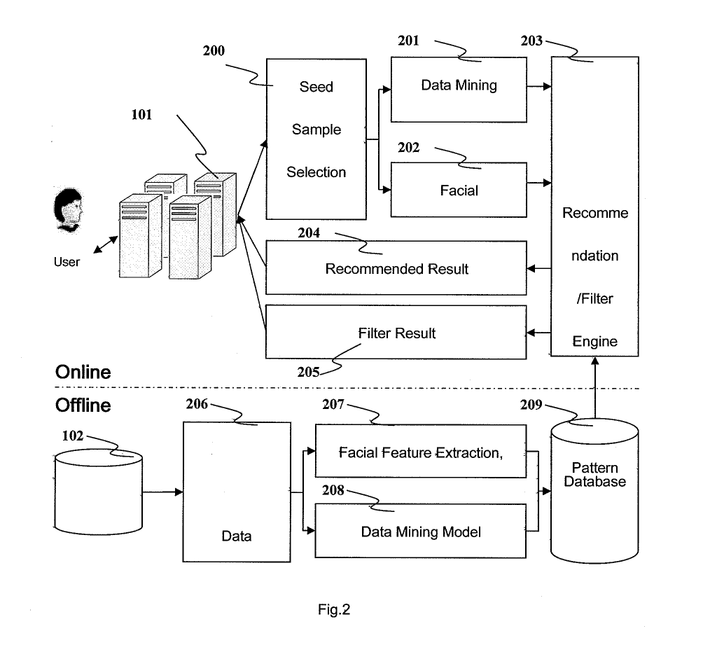

FIG. 2 depicts system framework and structure. The system includes two parts: offline part and online part.

In the offline part, original data obtained from the database are preprocessed by 206. Noise data are deleted and useful data for the next step are extracted in 206. Component 207 extracts facial features and categorized faces into different classes. Here, facial features can be extracted by different methods like Principal Components Analysis (PCA), Independent Component Analysis (ICA), Linear Discriminant Analysis (LDA) or geometric features extraction but not limited in the above methods. The method of categorized faces into different classes can be realized by different methods like K-means, ISODATA, complete linkage method but not limited in the above methods. Component 208 mines the relationship between different profiles and faces by data mining technologies. All information obtained from 207 and 208 components are saved in 209 database.

In the online part of FIG. 2, user accesses the system by 101. When registering into the system the user inputs his or her personal profile which consists of answering questions about his/her self and his/her ideal match. 202 generates the number of seed samples 200 automatically, according to user's input profile which provide reference for user to select in advance samples that he/she is attracted to and not attracted to. For example, user first inputs his profile, White/Caucasian, male, age is 30, 6 feet 1 inch, open character etc. Based on his profile, 40 face images will be recommended to him. Based on these 40 images, he can make some modifications manually to determine the final seed samples by typing “+” and “−” on each face image (here, type “+” means a person to whom he/she is attracted and “−” means a person to whom he/she is not-attracted). From seed samples, attracted and non-attracted faces are mined and matched by 201 and 202 component. Finally, attracted recommendation results 204 and non-attracted filter results 205 generated by Recommendation/Filter Engine 203 which fuse the result from 201 and 202. Through 101, users obtain the final result.

In FIG. 3, the algorithm flow of finding attracted and non-attracted members are shown. In FIG. 3, component 200 is described as said FIG. 2 which generates seed samples. Said component 200 includes 4 subparts, 301, 302, 306 and 307. Component 301 generates attracted members seed samples generation automatically by data mining technologies. Component 302 provides functions for user to modify seed samples from 301 according to user's personal preference. Component 306 generates non-attracted members seed samples generation automatically by data mining technologies. Component 307 provides functions for user to modify seed samples from 306 according to user's personal preference.

Component 303 mines the potential attracted member class based on seed samples through which it finds some potential attracted member class omitted in 200. Component 308 mines the potential non-attracted member class based on seed samples through which it can find some potential non-attracted member class omitted in 200. Attracted members are matched based on 303. The most attracted members are listed and displayed to user through 305. Non-attracted members are matched based on 309. The most non-attracted members are listed or filtered from user through 310.

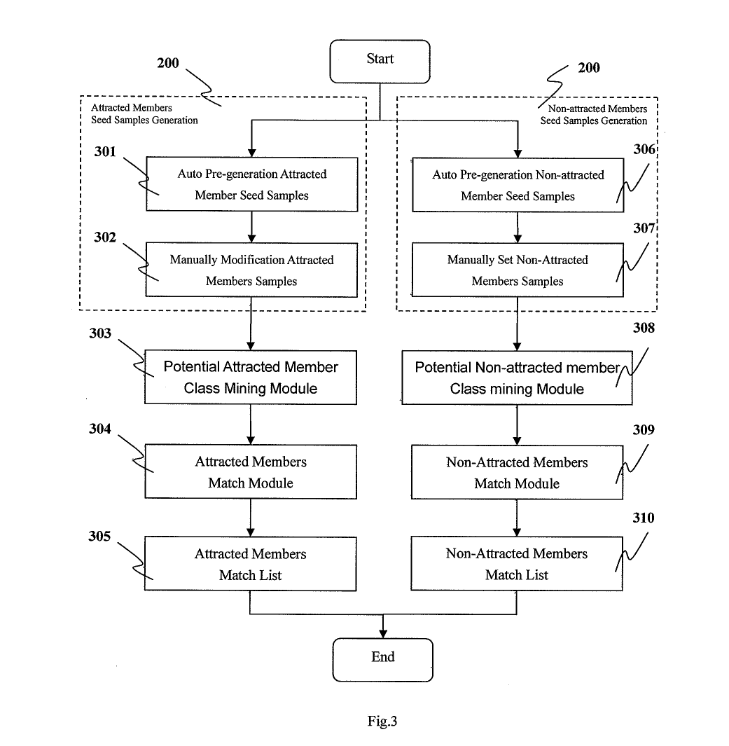

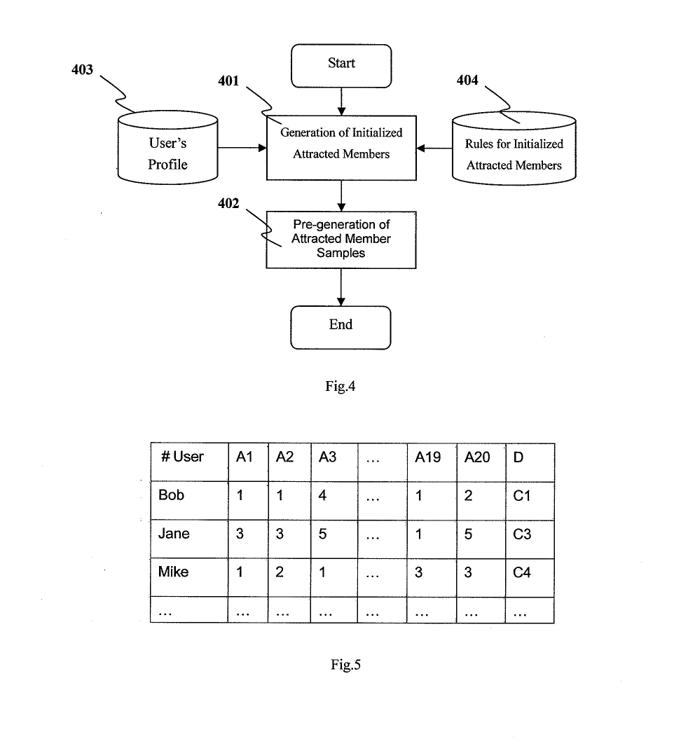

FIG. 4 depicts the flow of 301 in detail. 401 generates initialized attracted members by taking advantage of information from user's profile 403 and rules for initialized attracted members 404. Then a number of sample members are selected from said component 401 and saved in 402. Here, the number is established in advance according to the system requirement but it can also be established by user's requirement while the system only sets a range. For example, it can be set as 20 in 0˜100.

Here, we show a brief example to describe the generation of seed samples.

There is a database recording the history of users' behavior shown as FIG. 5.

In the FIG. 5, A1, A2, . . . A20 is the condition attribute, A1, A2, . . . A20 are the attributes which are summarized from the questionnaire (FIG. 16) of user's profile. For example, the content in the “Personality” assessment section in the questionnaire can be regarded as attributes. “Assertive” is A1, “Energetic” is A2, . . . , “Patient” is A20. Each of them has five selection options “Least Accurate”, “Slightly Not Accurate”, “Medium Accuracy”, “Slightly Accurate”, “Most Accurate”. These five selection options can be quantized as 5 numbers from 1˜5. Decision attribute includes 40 classes from C1˜C40. C1˜C40 means the categories of divided faces. Take Bob as an example, the record of Bob means when Bob's “Assertive” is “Least Accurate”, “Energetic” is “Least Accurate”, . . . , “Patient” is “Most Accurate”, the final matched faces he selected belong to C1.

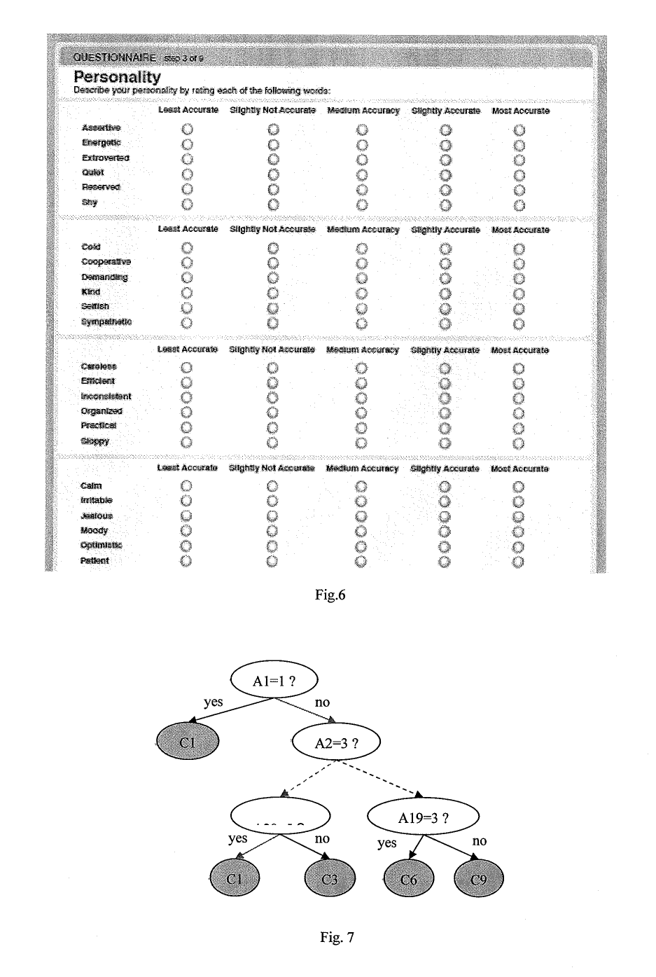

Based on FIG. 5, a rules tree can be built by using decision tree methods in which leaf node is decision attribute and intermediate node is condition attribute (like FIG. 7). Once the rules tree is built, rules can be used directly. For example, for a new user, when he registers in to the website, he will be required to fill out the questionnaire. For example, his questionnaire is A1=2, A2=3, . . . , A20=5, C1 class can be obtained by using the rules tree. Then 40 images selected from C1 will be recommended as seed samples for user's future selection.

FIG. 8 depicts the flow of 306 in detail. 801 generates initialized non-attracted members by taking advantage of information from user's profile 803 and rules for initialized non-attracted members 804. Then a number of sample members are selected from said component 801 and saved in 802. Here, the number is established in advance according to the system requirement but it can also be established by user's requirement while the system only sets a range. For example, it can be set as 20 in 0˜100.

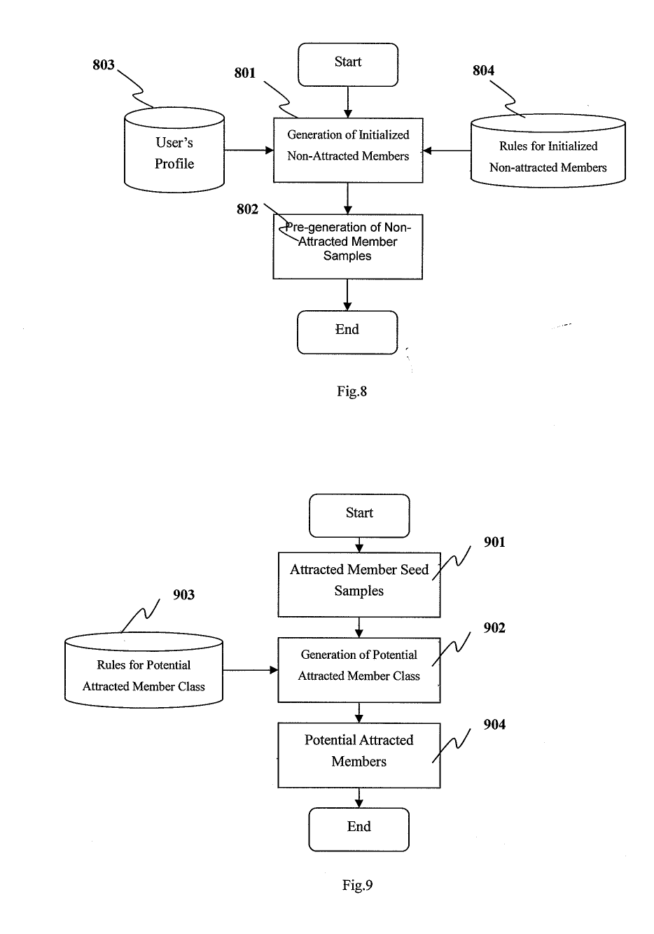

FIG. 9 depicts potential attracted member class mining module (Component 303 in FIG. 3) in detail. Based on attracted member seed samples 901, rules for potential attracted member class 903 are applied to generate potential attracted member class 902. Here, data in 901 are obtained from manually modified attracted member samples (302). Then from 902, potential attracted members can be generated. Here, the number of the attracted member class depends on the rules from 903 by data mining method while the number of 904 can be pre-set by the system.

Here, we show a brief example to describe how to generate a potential class. There is a database recording the history of users' behavior shown as FIG. 10.

In the table, C1, C2, . . . C40 is the condition attribute, C1, C2, . . . C40 are the attributes which are ace classes divided in the database. Each of the classes have two values, 0 and 1 in which 1 means the class is selected by user while 0 means the class is not selected by user. D is the decision attribute which means the final selection decision of user.

Take Bob as an example, the record means Bob's selected images from C1, C3, . . . , and C39 from the database based on seed samples. After that, Bob chose the image from C1 as his dating target. The same as Jane, Mike, . . . .

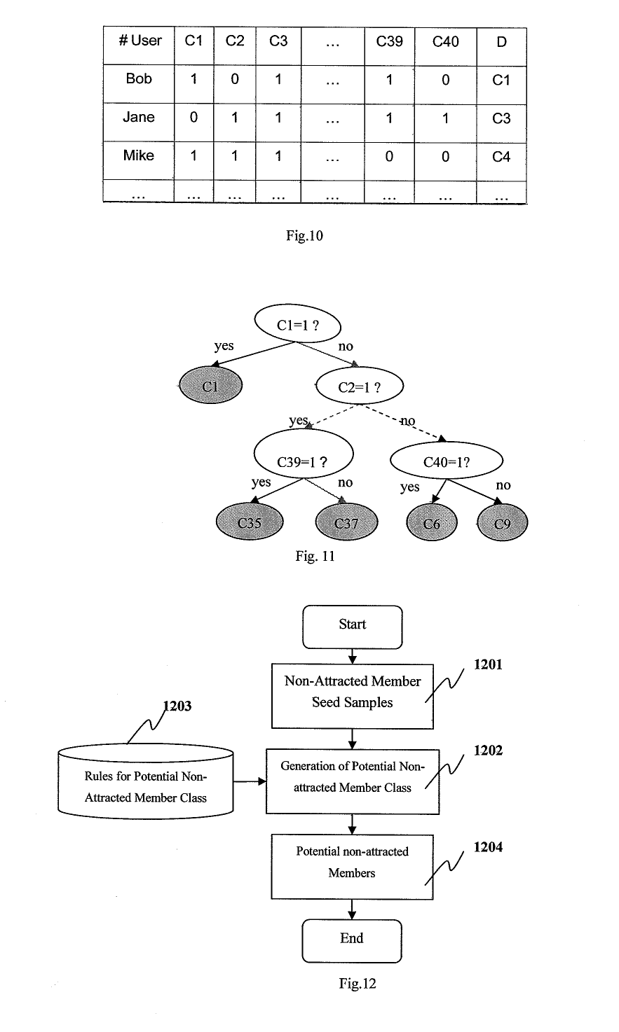

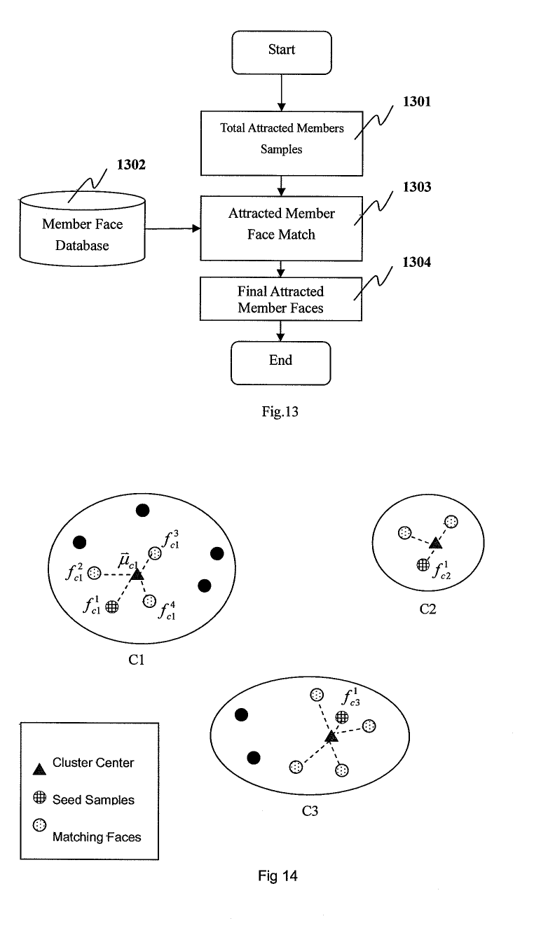

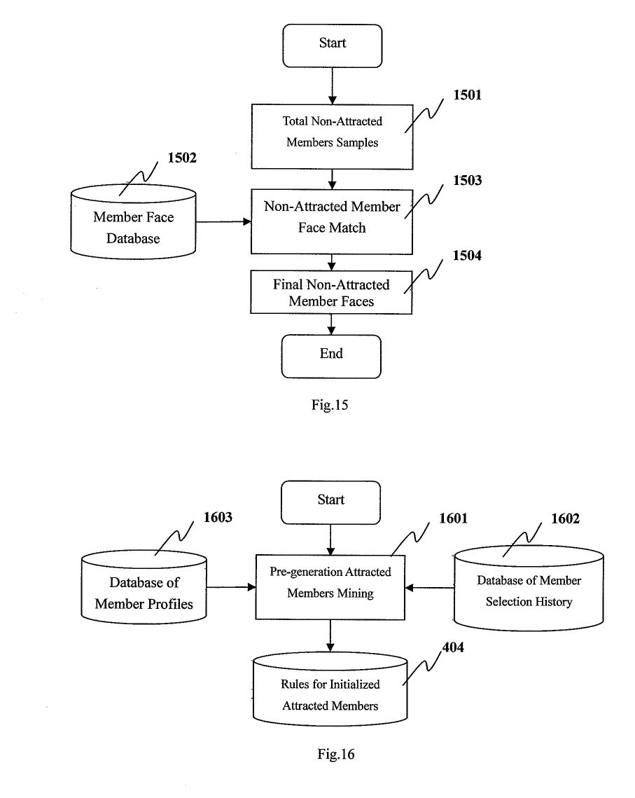

Based on FIG. 10, a rules tree can be built by using decision tree methods in which leaf node is decision attribute and intermediate node is condition attribute (like FIG. 11.). Once the rules tree is built, rules can be used directly. For example, for a new user, when he registers in to the website, the system will recommend 24 seed images for him. He will modify the samples by typing “+” and “−”. Then, the system can analyze that he selected C2, C3 and C5 class. According to C1, C2 and C5, system can recommend C37 by using the rules tree as an additional potential class to him to extend his selection scale.

FIG. 12 depicts potential non-attracted member class mining module (Component 308 in FIG. 3) in detail. Based on non-attracted member seed samples 1201, rules for potential non-attracted member class 1203 are applied to generate potential non-attracted member class 1202. Here, data in 1201 are obtained from manual modification of non-attracted member samples (307). Then from 1202, potential non-attracted members can be generated. Here, the number of the non-attracted member class depends on the rules from 1203 by data mining method while the number of 1204 can be pre-set by the system.

After obtaining potential attracted members in 904 and manual modification of samples 302, total attracted member samples 1301 are obtained by combining them together. Attracted member samples 1301 are matched with faces saved in the database 1302 and the faces most close to the samples are selected from database 1304 to form final attracted member faces.

Different from traditional face recognition model, 1303 is a model of attracted member face match which also involves recommending attracted faces to user according to their priorities. Shown as FIG. 14, dots with gridlines are seed facial samples obtained from 1301. Dot with points means faces most similar to seed sample. Triangle means the cluster center of dots with points and gridlines. C₁, C₂, C₃ are the classes generated by 201. Suppose ƒ_{c1}¹, ƒ_{c2}¹, ƒ_{c3}¹ are samples generated from 303. ƒ_{c1}², ƒ_{c1}³, ƒ_{c1}⁴ are the faces most similar with ƒ_{c1}¹ in class C₁. The same as ƒ_{c1}¹, ƒ_{c2}², ƒ_{c2}³, ƒ_{c2}⁴ are the faces most similar with ƒ_{c2}¹ in class C₂, ƒ_{c3}², ƒ_{c3}³, ƒ_{c3}⁴ are the faces most similar with ƒ_{c3}¹ in class C₃. \vec{μ}_{c1} is the mean value of ƒ_{c1}¹, ƒ_{c1}², ƒ_{c1}³, ƒ_{c1}⁴. \vec{μ}_{c2} is the mean value of ƒ_{c2}¹, ƒ_{c2}², ƒ_{c2}³, ƒ_{c2}⁴. \vec{μ}_{c3} is the mean value of ƒ_{c3}¹, ƒ_{c3}², ƒ_{c3}³, ƒ_{c3}⁴. d is the distance between faces and cluster center. Thus, different distances can be obtained as following.

(ƒ_{c1}¹,d_{c1}¹),(ƒ_{c1}²,d_{c1}²),(ƒ_{c1}³,d_{c1}³)

(ƒ_{c2}¹,d_{c2}¹),(ƒ_{c2}²,d_{c2}²),(ƒ_{c2}³,d_{c2}³)

(ƒ_{c3}¹,d_{c3}¹),(ƒ_{c3}²,d_{c3}²),(ƒ_{c3}³,d_{c3}³)

Here, P(ƒᵢ,Cᵢ) is defined as a matching degree.

Matching Degree:

$$P ( {f}_{i} , {C}_{i} ) = P ( {f}_{i} \vert {C}_{i} ) P ( {C}_{i} ) = {( \frac{{d}_{{c}_{i}}^{{f}_{i}}}{{\sum }_{fi ∈ {C}_{i}} {d}_{{c}_{i}}^{fi}} )}^{- 1} \cdot \frac{\vert {C}_{i} \vert}{{\sum }_{i} {C}_{i}}$$

In which ƒᵢ is a matched facial feature vector. Cᵢ is the category of ƒᵢ which built by said cluster procedure. d_{c}_{ᵢ}^{fi} is the distance between ƒᵢ and its cluster center

$${\vec{μ}}_{ci} \cdot {\sum }_{fi ∈ {C}_{i}} {d}_{{c}_{i}}^{fi}$$

is the summary of distance of all faces close to \vec{μ}_{ci}. |Cᵢ| is the number of features included in

$${C}_{i} \cdot {\sum }_{i} {C}_{i}$$

is summary of all categories. Faces are recommended to user according to their priority of matching degree P(ƒᵢ,Cᵢ). P(ƒᵢ,Cᵢ) is bigger, ƒᵢ has a higher priority for user.

After obtaining potential non-attracted members in 1204 and manual modification samples 307, total non-attracted member samples 1501 are obtained by combining them together. Non-attracted member samples 1501 are matched with faces saved in the database 1502 and the faces most close to the samples are selected from database 1504 to form final non-attracted member faces.

FIG. 16 graphs the detailed flow of building rules for initialized attracted members 404. Based on the information from the database of member profiles 1603 and member selection history 1602, the relationship between user's profile, behavior and preferences are mined by component 1601. The rules are saved in 404. Here, the process of building rules for initialized attracted members is executed in the offline stage and does not cost system running time in the online stage.

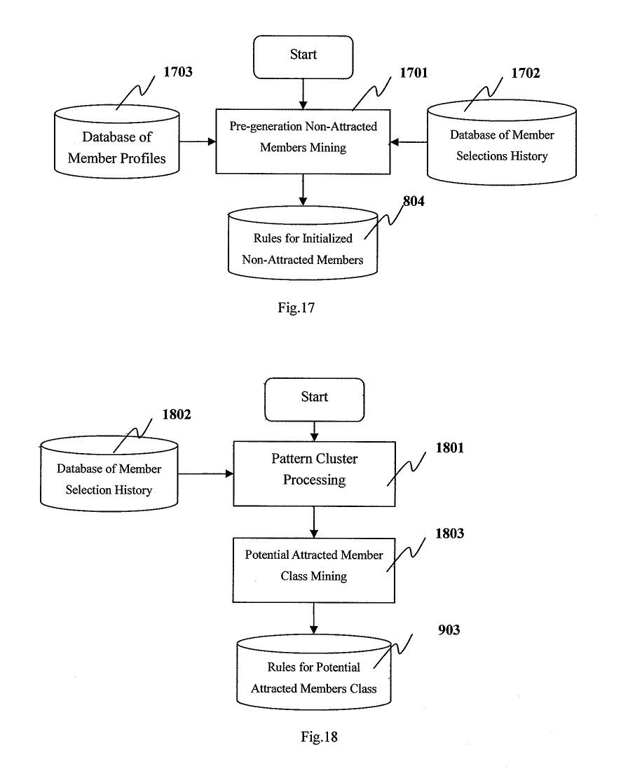

FIG. 17 graphs the detailed flow of building rules for initialized non-attracted members 804. Based on the information from the database of member profiles 1703 and member selection history 1702, the relationship between user's profile, behavior and preferences are mined by component 1701. The rules are saved in 804. Here, the process of building rules for initialized non-attracted members is executed in the offline stage and does not cost system running time in online stage.

FIG. 18 graphs the detailed flow of building rules for potential attracted member classes 903. The attracted face data are clustered into different classes 1801 first by different cluster methods like K-means, ISODATA etc. Based on the information from database of member selection history 1802, potential attracted member classes are mined by component 1803. The rules are saved in 903. Here, the process of building rules for potential attracted member classes is executed in the offline stage and does not cost system running time in the online stage.

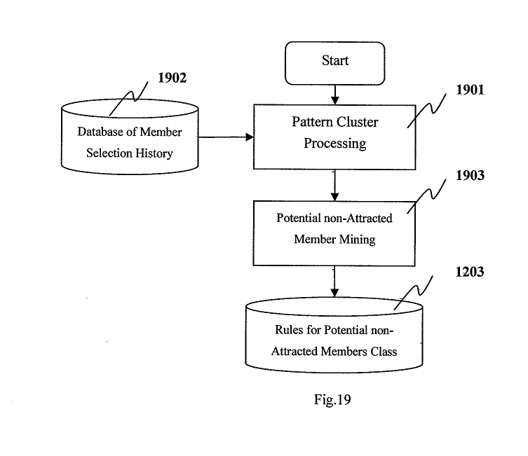

FIG. 19 graphs the detailed flow of building rules for potential non-attracted member classes 1203. The non-attracted face data are clustered into different classes 1901 first by different cluster methods like K-means, ISODATA etc. Based on the information from database of member selection history 1902, potential non-attracted member classes are mined by component 1903. The rules are saved in 1203. Here, the process of building rules for potential non-attracted member classes is executed in the offline stage and does not cost system running time in the online stage.

What is claimed is:

1. A dating recommendation system operable on a computer, comprising:
A members database for receiving and maintaining inputs from a plurality of users of their respective profiles and face photographs as members in the recommendation system;
A seed sample generation module for generating a seed sample of members photographs from a user's profile input and providing the seed sample to the user sending the dating recommendation request for manual selection of those members photographs in the seed sample that said user is attracted to;
A potential attracted member class mining module for generating a potential attracted members list based upon analysis of closeness of features of the face photographs of members maintained in the members database to photographs of the seed sample that the user selects as being attracted to;
and
A match module for analyzing the user's selection of attracted members photographs of the seed sample in order to determine a dating recommendation match list.

2. The system of claim 1, further comprising:
An attracted members match module which receives the manual selection of attracted samples of members photographs in the seed sample that said user is attracted to and matches the closest face photographs from the members database with the attracted samples for recommendation of dating matches based upon closeness of matching face photographs according to face matching priorities.

3. The system of claim 1, further comprising:
A potential non-attracted member class mining module for generating a potential non-attracted members list based upon analysis of closeness of features of the face photographs of members maintained in the members database to photographs of the seed sample that the user selects as being not attracted to;
A non-attracted members match module which receives the manual selection of non-attracted samples of members photographs in the seed sample that said user is not attracted to and omits the closest face photographs from the members database with the non-attracted samples from recommendation of dating matches to said user.

4. The system of claim 2, further comprising:
A component of attracted mining rules for filtering attracted members according to rules for patterning relationship between a user profile and attracted face photograph preference history selection; and
A database of rules for filtering potential attracted member class which includes rules for patterning the relationship between different attracted face photograph classes.

5. The system of claim 3, further comprising
A component of non-attracted mining rules for filtering non-attracted members according to rules for patterning relationship between a user profile and non-attracted face photograph preference history selection; and
A database of rules for filtering potential non-attracted member class which includes rules for patterning relationship between different non-attracted face classes.

6. The system of claim 4, wherein the component of attracted mining rules employs an attracted mining model that builds a database of rules for initialized attracted members based on the members database of all users' profiles and users' attracted member face photograph selection history records.

7. The system of claim 4, wherein the component of attracted mining rules employs a mining model that builds a database of rules for potential attracted member class based on the members database of all users' attracted member face classes selection history records.

8. The system of claim 5, wherein the component of non-attracted mining rules employs a mining model that builds a database of rules for initialized non-attracted members based on the members database of all users' profiles and users' non-attracted member face photograph selection history records.

9. The system of claim 5, wherein the component of non-attracted mining rules employs a mining model that builds a database of rules for potential non-attracted member class based on the members database of all users' non-attracted member face classes selection history records.

10. The system of claim 1, further comprising an attracted members match means for extracting attracted facial features from original member face photographs, attracted facial class matching means for finding relationship between attracted seed samples and attracted classes of member face photographs in the members database, and attracted facial matching means for finding relationship between attracted seed samples and attracted member face photographs in the attracted facial classes.

11. The system of claim 3, further comprising a non-attracted members match means for extracting non-attracted facial features from original member face photographs, non-attracted facial class matching means for finding relationship between non-attracted seed samples and non-attracted classes of member face photographs in the members database, and non-attracted facial matching means for finding relationship between non-attracted seed samples and non-attracted member face photographs in the non-attracted facial classes.

12. A method of dating recommendation operable on a computer, comprising:
Receiving and maintaining in a members database inputs from a plurality of users of their respective profiles and face photographs as members in the recommendation system;
Generating a seed sample of members photographs from the user's input profile and providing the seed sample to the user sending the dating recommendation request for manual selection of those members photographs in the seed sample that said user is attracted to;
Generating a potential attracted members list based upon analysis of closeness of features of the face photographs of members maintained in the members database to photographs of the seed sample that the user selects as being attracted to;
and
Analyzing the user's selection of attracted members photographs of the seed sample in order to determine a dating recommendation match list.

13. The method of claim 12, further comprising:
Receiving the manual selection of attracted samples of members photographs in the seed sample that said user is attracted to and matching the closest face photographs from the members database with the attracted samples for recommendation of dating matches based upon closeness of matching face photographs according to face matching priorities.

14. The method of claim 12, further comprising:
Generating a potential non-attracted members list based upon analysis of closeness of features of the face photographs of members maintained in the members database to photographs of the seed sample that the user selects as not being attracted to; and
Receiving the manual selection of non-attracted samples of members photographs in the seed sample that said user is not attracted to and omits the closest face photographs from the members database with the non-attracted samples from recommendation of dating matches to said user.

15. The method of claim 13, further comprising:
Filtering attracted members according to rules for patterning relationship between a user profile and attracted face photograph preference history selection; and
Filtering potential attracted member class which includes rules for patterning the relationship between different attracted face photograph classes.

16. The method of claim 14, further comprising
Filtering non-attracted members according to rules for patterning relationship between a user profile and non-attracted face photograph preference history selection; and
Filtering potential non-attracted member class which includes rules for patterning relationship between different non-attracted face classes.

17. The method of claim 12, further comprising extracting attracted facial features from original member face photographs, finding relationship between attracted seed samples and attracted classes of member face photographs in the members database, and finding relationship between attracted seed samples and attracted member face photographs in the attracted facial classes.

18. The method of claim 14, further comprising extracting non-attracted facial features from original member face photographs, finding relationship between non-attracted seed samples and non-attracted classes of member face photographs in the members database, and finding relationship between non-attracted seed samples and non-attracted member face photographs in the non-attracted facial classes.
